(19) United States
(12) Patent Application Publication
(10) Pub. No.: US 2011/0095064 A1
(43) Pub. Date: Apr. 28, 2011

(54) FUEL LEVEL MONITORING SYSTEM FOR COMBUSTION-POWERED TOOLS

(76) Inventors: Walter J. Taylor, McHenry, IL (US); J. Westley Schwartzenberger, Northlake, IL (US); Daniel J. Birk, McHenry, IL (US); Joseph R. Dicello, JR., Beach Park, IL (US)

(21) Appl. No.: 12/604,042

(22) Filed: Oct. 22, 2009

(51) Int. Cl. B21J 15/28; B25C 1/08

(52) U.S. Cl. 227/2; 227/9

(57) ABSTRACT

A fuel cell includes a spark initiator configured to initiate spark events, and a fuel level monitoring system configured for monitoring the fuel level in the fuel cell and indicating the monitored fuel level to a user. Included in the fuel level monitoring system is a programmable control unit configured to control the spark initiator and to count the spark events initiated by the spark initiator, to compare a number of spark events with at least two predetermined ranges of spark events, and to determine the fuel level in the fuel cell based on the determinations. An indicator controlled by the programmable control unit is supplied for providing the user with an indication of the fuel level in the fuel cell.

### BACKGROUND

The present invention relates generally to handheld power tools, and specifically to combustion-powered fastener-driving tools, also referred to as combustion tools or combustion nailers. More specifically, the present invention relates to such combustion tools using replaceable fuel cells, also called fuel canisters.

Combustion-powered tools are known in the art, and one type of such tools, also known as IMPULSE® brand tools for use in driving fasteners into workpieces, is described in commonly assigned patents to Nikolich U.S. Pat. Re. No. 32,452, and U.S. Pat. Nos. 4,522,162; 4,483,473; 4,483,474; 4,403,722; 5,197,646; 5,263,439 and 6,145,724, all of which are incorporated by reference herein. Similar combustion-powered nail and staple driving tools are available commercially from ITW-Paslode (a division of Illinois Tool Works, Inc.) of Vernon Hills, Ill. under PASLODE® brand. As exemplified in the above-listed patents, it is known to use a disposable fuel cell for dispensing a pressurized hydrocarbon fuel to a combustion gas-powered tool. In particular, a suitable fuel cell is described in Nikolich U.S. Pat. No. 5,115,944, which is incorporated by reference herein.

Such tools incorporate a tool housing enclosing a small internal combustion engine. The engine is powered by the fuel cell, a canister of pressurized fuel gas. A battery-powered electronic power distribution unit produces a spark for ignition, and a fan located in a combustion chamber provides for both an efficient combustion within the chamber, while facilitating processes ancillary to the combustion operation of the device. The engine includes a reciprocating piston with an elongated, rigid driver blade disposed within a single cylinder body.

Upon the pulling of a trigger switch, which causes the spark to ignite a charge of gas in the combustion chamber of the engine, the combined piston and driver blade is forced downward to impact a positioned fastener and drive it into the workpiece. The piston then returns to its original, or pre-firing position, through differential gas pressures within the cylinder. Fasteners are fed magazine-style into the nosepiece, where they are held in a properly positioned orientation for receiving the impact of the driver blade.

As the combustion tool is operated, the fuel in the cell is progressively depleted. As this occurs, the internal fuel cell pressure drops until the cell is empty, or has insufficient fuel for further fastener-driving combustion events.

When the tool fails to fire, the first impulse is typically for the user to remove the fuel cell from the tool to determine whether an empty fuel cell is the cause. However, it is often difficult to gauge how much fuel remains in the fuel cell. In some instances, the tool fails to misfire for reasons unrelated to the fuel cell, and otherwise usable fuel cells are disposed of.

### BRIEF SUMMARY

The present combustion tool employing a fuel cell includes a spark initiator configured to initiate spark events, and a fuel level monitoring system configured for monitoring the fuel level in the fuel cell and indicating the monitored fuel level to a user. Included in the fuel level monitoring system is a programmable control unit configured to control the spark initiator and to count the spark events initiated by the spark initiator, to compare a number of spark events with at least two predetermined ranges of spark events, and to determine the fuel level in the fuel cell based on the determinations. An indicator controlled by the programmable control unit is supplied for providing the user with an indication of the fuel level in the fuel cell.

More specifically, a fuel level monitoring system for monitoring the fuel level in a fuel cell, and for indicating the monitored fuel level to a user, is provided. The system includes a programmable control unit configured to count spark events initiated by a spark initiator of the tool. The system compares a number of spark events with at least two predetermined ranges of spark events, and determines the fuel level in the fuel cell based on the determinations. An indicator is controlled by the programmable control unit for providing the user with an indication of the fuel level in the fuel cell. A reset device is configured to reset the number of spark events counted by the programmable control unit to zero.

In another embodiment, a method of monitoring and indicating a fuel level of a fuel cell in a combustion tool includes providing at least two predetermined ranges of spark events, counting the number of spark events in the tool, and comparing the number of spark events with the at least two predetermined ranges of spark events. The method further includes indicating the fuel level in the fuel cell with an indicator.

### BRIEF DESCRIPTION OF THE DRAWINGS

FIG. 1 is a front perspective view of a combustion tool suitable for use with the present fuel level monitoring system;

FIG. 2 is a fragmentary vertical cross-section of the combustion tool of FIG. 1;

FIG. 3 is a fragmentary perspective view of the rear of the combustion tool having an indicator and a reset device; and

FIG. 4 is a schematic of the connection of the indicator, the reset device and a programmable control unit of the present fuel level monitoring system.

### DETAILED DESCRIPTION

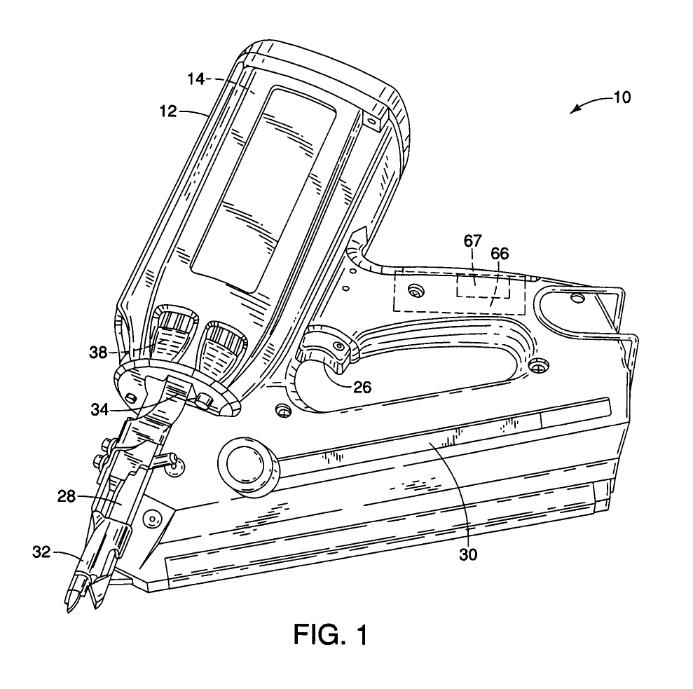

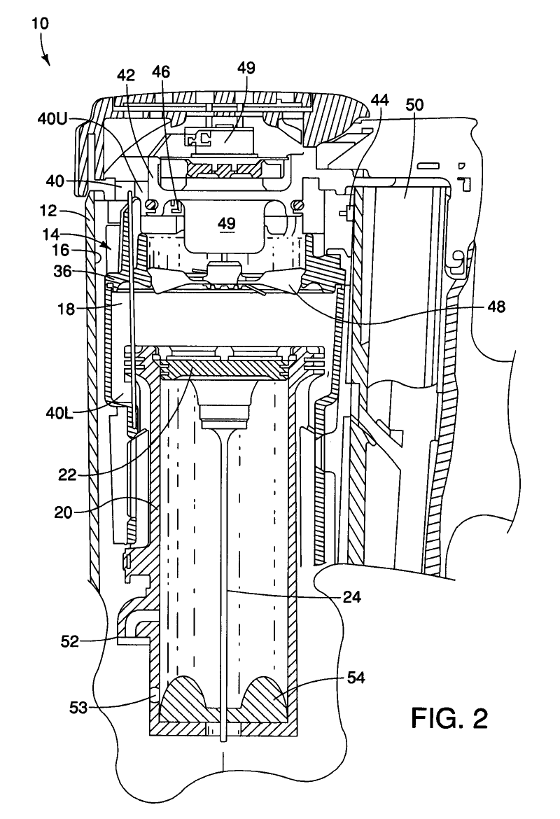

Referring now to FIGS. 1 and 2, a combustion-powered, fastener-driving tool suitable for incorporating the present handle housing is generally designated 10. While the tool 10 is depicted as being of the type described in the patents listed above, other types of combustion tools are contemplated as having the potential of incorporation of the present fuel level monitoring system.

A housing 12 of the tool 10 encloses a self-contained internal power source 14, within a housing main chamber 16. As in conventional combustion tools, the power source 14 is powered by internal combustion and includes a combustion chamber 18 that communicates with a cylinder 20. A piston 22 reciprocally disposed within the cylinder 20 is connected to the upper end of a driver blade 24. As shown in FIG. 2, an upper limit of the reciprocal travel of the piston 22 is referred to as a top dead center or pre-firing position, which occurs just prior to firing, or the ignition of the combustion gases which initiates the downward driving of the driver blade 24 to impact a fastener (not shown) to drive it into a workpiece.

Through depression of a trigger 26, an operator induces combustion within the combustion chamber 18, causing the driver blade 24 to be forcefully driven downward through a nosepiece 28 (FIG. 1). The nosepiece 28 guides the driver blade 24 to strike a fastener that had been delivered into the nosepiece via a fastener magazine 30.

Included in the nosepiece 28 is a workpiece contact element 32, which is connected, through a linkage 34 to a reciprocating valve sleeve 36, an upper end of which partially defines the combustion chamber 18. Depression of the tool housing 12 against the workpiece contact element 32 in a downward direction as seen in FIG. 1 (other operational orientations are contemplated as are known in the art), causes the workpiece contact element to move from a rest position to a pre-firing position. This movement overcomes the normally downward biased orientation of the workpiece contact element 32 caused by a spring 38 (shown hidden in FIG. 1).

Through the linkage 34, the workpiece contact element 32 is connected to and reciprocally moves with, the valve sleeve 36. In the rest position (FIG. 2), the combustion chamber 18 is not sealed, since there is an annular gap 40 including an upper gap 40U separating the valve sleeve 36 and a cylinder head 42, which accommodates a chamber switch 44 and a spark initiator 46, such as a spark plug, and a lower gap 40L separating the valve sleeve 36 and the cylinder 20. The spark initiator 46 is in fluid communication with the combustion chamber 18.

In the preferred embodiment of the present tool 10, the cylinder head 42 also is the mounting point for at least one cooling fan 48 and the associated fan motor 49 which extends into the combustion chamber 18 as is known in the art and described in the patents which have been incorporated by reference above. In the rest position depicted in FIG. 2, the tool 10 is disabled from firing because the combustion chamber 18 is not sealed at the top with the cylinder head 42 and the chamber switch 44 is open.

Firing is enabled when an operator presses the workpiece contact element 32 against a workpiece. This action overcomes the biasing force of the spring 38, causes the valve sleeve 36 to move upward relative to the housing 12, closing the gap 40, sealing the combustion chamber 18 and activating the chamber switch 44. This operation also induces a measured amount of fuel to be released into the combustion chamber 18 from a replaceable fuel cell 50 (shown in fragment).

In a mode of operation known as sequential operation, upon a pulling of the trigger 26, the spark initiator 46 is energized, igniting the fuel and air mixture in the combustion chamber 18 and sending the piston 22 and the driver blade 24 downward toward the waiting fastener for entry into the workpiece. The ignition of the fuel and air mixture by the spark initiator 46 is known as a “spark event”. As the piston 22 travels down the cylinder 20, it pushes a rush of air which is exhausted through at least one petal, reed or check valve 52 and at least one vent hole 53 located beyond the piston displacement (FIG. 2). At the bottom of the piston stroke or the maximum piston travel distance, the piston 22 impacts a resilient bumper 54 as is known in the art. With the piston 22 beyond the exhaust check valve 52, high pressure gasses vent from the cylinder 20. Due to internal pressure differentials in the cylinder 20, the piston 22 is drawn back to the pre-firing position shown in FIG. 1.

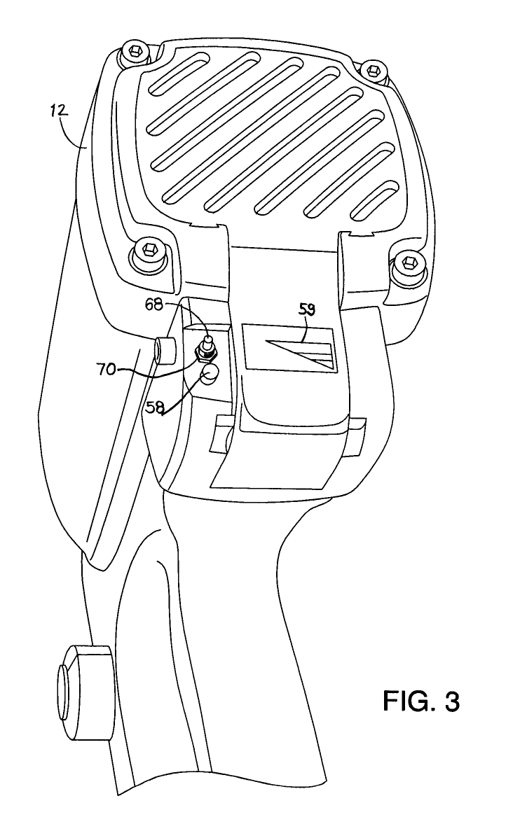

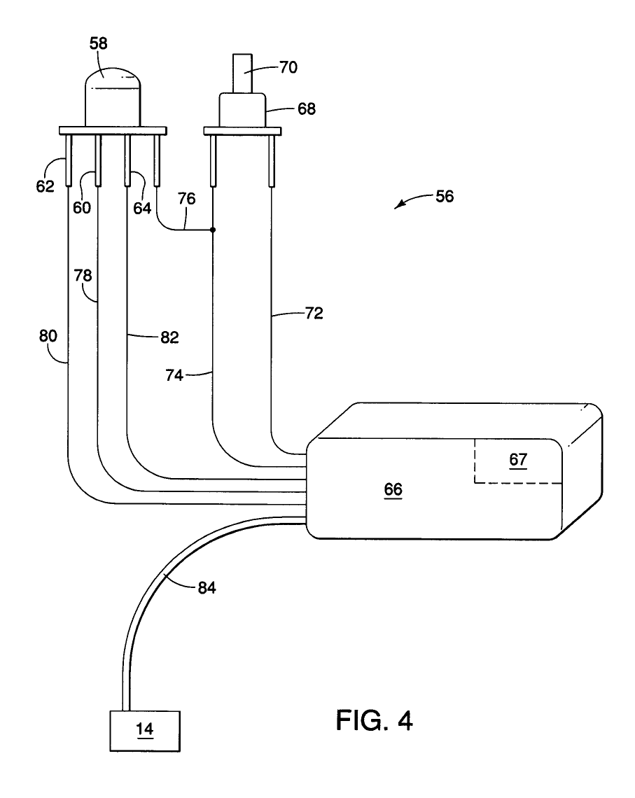

Referring now to FIGS. 3 and 4, a fuel level monitoring system suitable for use with the tool 10 is generally designated 56 and is configured for monitoring the level of fuel in the fuel cell 50 and for indicating the monitored condition to a user. In the present application, the condition of the fuel cell 50 will generally relate to the amount or level of fuel remaining in the fuel cell 50. As described in U.S. Pat. No. 6,722,550, incorporated by reference herein, it is known to monitor fuel levels by determining the pressure of the fuel emitted from the fuel cell 50, or by determining the flow of the fuel as it is emitted from the fuel cell 50 to the combustion chamber 18.

In the present fuel level monitoring system 56, the amount of the fuel in the fuel cell 50 is determined by the number of shots fired or “spark events” in the combustion chamber 18 of the tool 10. Typically, each fuel cell 50 has fuel for about 1,200 spark events. As is known in the art, one spark event is needed each time a fastener is driven by the tool 10. By counting the number of spark events or the number of shots fired, the fuel level monitoring system 56 can estimate the amount of fuel that remains in the fuel cell 50.

An indicator 58 is disposed at a visible location on the tool 10, for example the rear of the tool, however it is contemplated that the indicator may be placed anywhere on the housing 12 that is convenient and easy for the user to read. In the present embodiment, the indicator 58 is at least one LED. The indicator 58 is configured for indicating the amount of fuel remaining in fuel cell 50 or whether the fuel cell requires replacement, for example by the number or color of LED's. While the present fuel level monitoring system 56 uses LEDs as indicators 58, it should be appreciated that other indicators can be used.

In one embodiment, the indicator 58 has a green LED 60 that is illuminated to indicate a first predetermined range of spark events of the tool 10 with the fuel cell 50, for example 0 to 1,000 spark events. An illuminated green LED indicates to the user that the fuel cell 50 has ample fuel. When a second predetermined range of spark events is reached, for example 1,001 to 1,200 spark events, a yellow LED 62 is illuminated to indicate that the fuel in the fuel cell 50 is low. When a third predetermined range of spark events is reached, for example 1,201 and up, a red LED 64 is illuminated to indicate that the fuel in the fuel cell 50 is currently depleted or will soon be depleted.

The indicator 58 indicates at least two different fuel levels that correspond to the at least two predetermined ranges of spark events. It should be appreciated that the amount of LEDs and predetermined ranges can vary. Further, it should be appreciated that other colors of LED, the flashing of LED, and the brightness of LED can be used as distinguishing indicators, among others. A legend 59 may be provided on the tool 10 to provide instruction to the user on what the indicator 58 is indicating, such as a color-coded chart corresponding to the colors of the LEDs.

The spark events or shots fired are counted by a programmable control unit 66 of the tool 10. The programmable control unit 66, preferably including a microprocessor, is preferably already employed in the tool 10 for coordinating combustion, as is known in the art in the patents made of record above. Upon the user pulling the trigger 26 (FIG. 1), among other things, the programmable control unit 66 energizes the spark plug 46, igniting the fuel and air mixture in the combustion chamber 18 (the “spark event”). The resulting combustion sends the piston 22 and the driver blade 24 downward toward the waiting fastener for entry into the workpiece (FIG. 2). A battery 65 (FIG. 4) powers the programmable control unit 66, which also includes a counter 67 that counts the amount of spark events. The counter 67 is preferably a software function within the programmable control unit 66, and the programmable control unit compares the number of spark events accumulated by the counter 67 with the above-identified predetermined stored ranges.

The counter 67 of the programmable control unit 66 is reset to zero by a reset device 68. In the present embodiment, the reset device 68 is a button or other switch 70 that is electrically connected to the programmable control unit 66. Each time a new fuel cell 50 is inserted into the tool 10, the user activates the reset device 68 to reset the counter of the programmable control unit 66, for example by pressing the button 70. It is possible that the reset device 68 can require activation by the user for a predetermined period of time, for example 3-seconds, to reset the counter 67. In this configuration, unintentional resetting of the counter 67 is avoided or reduced. Further, with the manual resetting of the reset device 68, the fuel cell 50 can be removed from the tool 10 and then placed back into the tool without interrupting the count. Alternatively, it is possible that automatic resetting of the reset device 68 can occur whenever a fuel cell 50 is placed into the tool 10.

Referring now to FIG. 4, while other circuits or connections are contemplated, it is preferred that a first wire 72 from the programmable control unit 66 provides power to the reset device 68, and a second wire 74 between the reset device and the programmable control unit grounds the reset device. A third wire 76 extends between the reset device 68 and the indicator 58 to ground the indicator.

The programmable control unit 66 also controls the indicator 58. A fourth wire 78 extends between the programmable control unit 66 and the green LED 60, a fifth wire 80 extends between the programmable control unit 66 and the yellow LED 62, and a sixth wire 82 extends between the programmable control unit 66 and the red LED 64. A seventh wire 84 extends between the programmable control unit 66 and the power source 14. It should be understood that the fuel level monitoring system 56 is not limited to the wiring described above.

Thus, it will be seen that the present fuel level monitoring system 56 provides a way for the user to easily monitor the level of fuel in the fuel cell 50. In this manner, tool 10 malfunctions may be more easily diagnosed, since time is not wasted on checking the fuel cell fuel level when that is not the cause for malfunction. In addition, users will not be forced to discard usable fuel cells 50 in the mistaken belief that they are empty. Further, the present system 56 is a less complex method of monitoring the fuel cell 50 fuel level than monitoring the pressure or flow of the fuel emitted from the fuel cell. In addition, fastener-driving production is made more efficient, in that the user knows precisely when to change the fuel cell 50.

While particular embodiments of the present fuel cell level monitoring system 56 and mechanism for a combustion-powered tool 10 have been described herein, it will be appreciated by those skilled in the art that changes and modifications may be made thereto without departing from the invention in its broader aspects and as set forth in the following claims.

1. A combustion tool employing a fuel cell containing fuel, comprising:
a spark initiator configured to initiate spark events;
a fuel level monitoring system for monitoring the fuel level in the fuel cell and for indicating the monitored fuel level to a user, wherein the monitoring system comprises:
a programmable control unit configured to control the spark initiator and to count spark events initiated by the spark initiator, the programmable control unit configured to compare a number of spark events with at least two predetermined ranges of spark events, and to determine the fuel level in the fuel cell based on the determinations; and
an indicator controlled by the programmable control unit for providing the user with an indication of the fuel level in the fuel cell.

2. The tool of claim 1 wherein the indicator indicates at least two different fuel levels that each correspond to one of the at least two predetermined ranges of spark events.

3. The tool of claim 1 wherein the fuel level monitoring system further comprises a reset device that resets the number of spark events counted by the programmable control unit to zero.

4. The tool of claim 3 wherein the reset device is a button that is pressed by the user for a predetermined amount of time.

5. The tool of claim 1 wherein the indicator is at least one LED.

6. The tool of claim 1 wherein the indicator displays a first color when the number of spark events is in a first predetermined range, the indicator displays a second color when the number of spark events is in a second predetermined range, and the indicator displays a third color when the number of spark events is in a third predetermined range.

7. The tool of claim 6 wherein the first color indicates that the fuel cell has ample fuel, the second color indicates that the fuel in the fuel cell is low, and the third color indicates that the fuel in the fuel cell is one of currently depleted and will soon be depleted.

8. The tool of claim 6 wherein the first predetermined range is about 0 to 1,000 spark events, the second predetermined range is about 1,001 to 1,200 spark events, and the third predetermined range is about 1,200 and higher.

9. The tool of claim 1 wherein the programmable control unit further comprises a counter that counts the number of spark events.

10. A fuel level monitoring system for monitoring the fuel level in a fuel cell of a combustion tool, and for indicating the monitored fuel level to a user, the system including:
a programmable control unit configured to count spark events initiated by a spark initiator of the tool, the programmable control unit comparing a number of spark events with at least two predetermined ranges of spark events, and determining the fuel level in the fuel cell based on the determinations;
an indicator controlled by the programmable control unit for providing the user with an indication of the fuel level in the fuel cell; and
a reset device configured to reset the number of spark events counted by the programmable control unit to zero.

11. The system of claim 10 wherein the indicator indicates at least two different fuel levels that each correspond to one of the at least two predetermined ranges of spark events.

12. The system of claim 10 wherein the indicator displays a first color when the number of spark events is in a first predetermined range, the indicator displays a second color when the number of spark events is in a second predetermined range, and the indicator displays a third color when the number of spark events is in a third predetermined range.

13. The system of claim 12 wherein the first color indicates that the fuel cell has ample fuel, the second color indicates that the fuel in the fuel cell is low, and the third color indicates that the fuel in the fuel cell is one of currently depleted and will soon be depleted.

14. A method of monitoring and indicating a fuel level of a fuel cell in a combustion tool, comprising:
providing at least two predetermined ranges of spark events;
counting the number of spark events in the tool;
comparing the number of spark events with the at least two predetermined ranges of spark events; and
indicating the fuel level in the fuel cell with an indicator.

15. The method of claim 14 further comprising the step of displaying a first color when the number of spark events is in a first predetermined range, displaying a second color when the number of spark events is in a second predetermined range, and displaying a third color when the number of spark events is in a third predetermined range.

16. The method of claim 14 further comprising the step of resetting the number of spark events to zero.

17. The method of claim 14 wherein said resetting step requires activating a switch for a predetermined amount of time.
